(19) United States
(12) Patent Application Publication
(10) Pub. No.: US 2008/0226803 A1
(43) Pub. Date: Sep. 18, 2008

(54) NATURAL FLAVORING AGENT FOR SUGAR-SWEETENED TEA BEVERAGE TO TASTE LIKE HIGH FRUCTOSE CORN SYRUP-SWEETENED BEVERAGE

(75) Inventors: Stephen A. Letourneau, Holmes Beach, FL (US); Wendy Chan, New York, NY (US); Thomas Lee, Scarsdale, NY (US); Hang Chen, White Plains, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: Concentrate Manufacturing Company of Ireland, Hamilton (BM)

(21) Appl. No.: 11/686,173

(22) Filed: Mar. 14, 2007

(51) Int. Cl. A23F 3/14

(52) U.S. Cl. 426/597

(57) ABSTRACT

Beverage products including at least a tea component, a natural nutritive sweetener present in an amount of at least 8% by weight and Lo Han Guo are provided. Beverage concentrates including at least a tea component, a natural nutritive sweetener present in an amount of at least 48% by weight and Lo Han Guo are also provided.

### TECHNICAL FIELD

This invention relates to sweetened tea beverages and other sweetened tea beverage products, such as beverage concentrates, etc. In particular, this invention relates to sweetened tea beverages and other beverage products having formulations suitable to meet market demand for alternative nutritional characteristics or flavor profiles in beverages.

### BACKGROUND

It has long been known to produce beverages of various formulations. Improved and new formulations are desirable to meet changing market demands. In particular, there is perceived market demand for beverages having alternative nutritional characteristics, including, for example, alternative calorie content. Also, there is perceived market demand for beverages having alternative flavor profiles, including good taste, mouthfeel, etc. In addition, there is consumer interest in beverages and other beverage products, such as beverage concentrates, whose formulations make greater use of natural ingredients, that is, ingredients distilled, extracted, concentrated or similarly obtained from harvested plants and other naturally occurring sources, with limited or no further processing.

The development of new beverage formulations, for example, new beverage formulations employing alternative sweeteners, flavorants, flavor enhancing agents and the like, presents challenges in addressing associated bitterness and/or other off-tastes. In addition, such challenges typically are presented in new beverage formulations developed for alternative nutritional and/or flavor profiles. Also, there is need for new beverage formulations which can satisfactorily meet the combination of objectives including nutritional characteristics, flavor, shelf life, and other objectives.

Development of new beverage formulations has faced obstacles. For example, U.S. Pat. No. 4,956,191 suggests that carbonated beverages which contain blends of saccharin or the Stevia extract with aspartame tend to be less organoleptically pleasing than those containing sugar.

It is therefore an object of the present invention to provide beverages and other beverage products such as beverage concentrates, etc. It is an object of at least certain embodiments of the invention (that is, not necessarily all embodiments of the invention) to provide beverages and other beverage products having desirable taste properties. It is an object of at least certain (but not necessarily all) embodiments of the invention to provide beverages and other beverage products having improved formulations. It is an object of at least certain (but not necessarily all) embodiments of the invention to provide beverages and other beverage products having formulations incorporating potent sweeteners, e.g., non-nutritive sweeteners, and being suitable to meet market demand for alternative nutritional characteristics or flavor profiles in beverages. It is an object of at least certain (but not necessarily all) embodiments of the invention to provide sweeteners that can be used to replace high fructose corn syrup in beverages and other beverage products that are typically sweetened with high fructose corn syrup. These and other objects, features and advantages of the invention or of certain embodiments of the invention will be apparent to those skilled in the art from the following disclosure and description of exemplary embodiments.

### SUMMARY

The beverage products disclosed here are based in part on the discovery of novel combinations of sweeteners that can be used to sweeten a tea beverage that is typically sweetened with high fructose corn syrup, to substantially preserve or closely replicate the taste, including mouthfeel of the beverage.

In accordance with a first aspect, beverage products that include at least a tea component, a natural nutritive sweetener present in an amount of at least 8% by weight, and Lo Han Guo are provided. The Lo Han Guo is a potent sweetener which can be provided as a natural nutritive or natural non-nutritive sweetener. In certain exemplary embodiments, the sweetened tea beverages further include at least an additional potent sweetener, e.g., a non-nutritive natural sweetener which is not Lo Han Guo. In certain exemplary embodiments, the natural nutritive sweetener is sucrose, fructose, glucose, and/or invert sugar or combinations thereof. In certain exemplary embodiments, the natural nutritive sweetener is sucrose. In certain exemplary embodiments, the Lo Han Guo is provided as juice concentrate (commercially available typically at 60-65 degrees Brix), which may optionally be present in the beverage in an amount from about 0.01% to 0.05% by weight or from about 0.03% to 0.04% by weight. In certain exemplary embodiments, the beverage products may contain caffeine or, alternatively, be decaffeinated. In still other exemplary embodiments, additional components including one or more of acid (e.g., one or more of phosphoric acid, citric acid, malic acid, tartaric acid, lactic acid, formic acid, ascorbic acid, gluconic acid, succinic acid, maleic acid and adipic acid), color, flavor composition, carbonation, nutritional supplement and emulsifying agent can be added to the beverage products. In yet other exemplary embodiments, the tea can include one or more of black tea, oolong tea, green tea and white tea.

In accordance with another aspect, beverage concentrates that include at least a tea component, a natural nutritive sweetener present in an amount of at least 48% by weight, and Lo Han Guo are provided. In certain exemplary embodiments, the sweetened tea beverage concentrates further include at least an additional potent sweetener, e.g., a non-nutritive natural sweetener. In certain exemplary embodiments, the natural nutritive sweetener is present in an amount of at least 8% by weight when the beverage concentrate is diluted to a full strength beverage product. In certain exemplary embodiments, the natural nutritive sweetener is sucrose, fructose, glucose, levulose and/or invert sugar or combinations thereof.

In certain exemplary embodiments, the natural nutritive sweetener is sucrose. In other exemplary embodiments, the Lo Han Guo is provided as juice concentrate, which may optionally be present in an amount from about 0.06% to 0.3% by weight or from about 0.18% to 0.24% by weight. In certain exemplary embodiments, the Lo Han Go juice concentrate is present in an amount from about 0.01% to 0.05% by weight or from about 0.03% to 0.04% by weight when the beverage concentrate is diluted to a full strength beverage product. In certain exemplary embodiments, the beverage products may contain caffeine or, alternatively, be decaffeinated. In still other exemplary embodiments, additional components including one or more of acid (e.g., one or more of phosphoric acid, citric acid, malic acid, tartaric acid, lactic acid, formic acid, ascorbic acid, gluconic acid, succinic acid, maleic acid and adipic acid), color, flavor composition, carbonation, nutritional supplement and emulsifying agent can be added to the beverage products. In yet other exemplary embodiments, the tea can include one or more of black tea, oolong tea, green tea and white tea.

In accordance with another aspect, full strength beverages produced by diluting a beverage concentrate that includes at least a tea component, a natural nutritive sweetener present in an amount of at least 48%, and Lo Han Guo with water, are provided. In certain exemplary embodiments, the full strength beverages include one part beverage concentrate and five parts water.

In accordance with another aspect, beverage products consisting of a tea component, sucrose present in an amount of at least 8% by weight and Lo Han Guo are provided.

It will be appreciated by those skilled in the art, given the benefit of the following description of certain exemplary embodiments of the beverage and other beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### DETAILED DESCRIPTION OF CERTAIN EXEMPLARY EMBODIMENTS

The present invention provides unique combinations of sweeteners for use in sweetened tea beverages and other sweetened tea beverage products, particularly those that are typically sweetened instead with only high fructose corn syrup. It should be understood that beverages and other beverage products in accordance with this disclosure may have any of numerous different specific formulations or constitutions. The formulation of a beverage product in accordance with this disclosure can vary to a certain extent, depending upon such factors as the product's intended market segment, its desired nutritional characteristics, flavor profile and the like. For example, it will generally be an option to add further ingredients to the formulation of a particular beverage embodiment, including any of the beverage formulations described below.

Additional (i.e., more and/or other) sweeteners may be added, flavorings, electrolytes, vitamins, fruit juices or other fruit products, tastents, masking agents and the like, flavor enhancers, and/or carbonation typically can be added to any such formulations to vary the taste, mouthfeel, nutritional characteristics, etc. In general, a beverage in accordance with this disclosure typically comprises at least water, sweetener, acidulant and flavoring. Exemplary flavorings which may be suitable for at least certain formulations in accordance with this disclosure include cola flavoring, citrus flavoring, spice flavorings and others. Carbonation in the form of carbon dioxide may be added for effervescence. Preservatives can be added if desired, depending upon the other ingredients, production technique, desired shelf life, etc. Optionally, caffeine can be added. Certain exemplary embodiments of the beverages comprising a natural nutritive sweetener and Lo Han Guo disclosed here are tea beverages, characteristically containing water, sweetener (e.g., sucrose, Lo Han Guo), tea, and/or other flavoring, optional coloring, and optionally other ingredients. Additional and alternative suitable ingredients will be recognized by those skilled in the art given the benefit of this disclosure.

The sweetened tea beverage products disclosed here include beverages, i.e., ready to drink liquid formulations, beverage concentrates and the like. Beverages include, e.g., carbonated and non-carbonated soft drinks, fountain beverages, frozen ready-to-drink beverages, dairy beverages, powdered soft drinks, as well as liquid concentrates, flavored waters, enhanced waters, fruit juice and fruit juice-flavored drinks, sport drinks, and alcoholic products. The terms “beverage concentrate” and “syrup” are used interchangeably throughout this disclosure. At least certain exemplary embodiments of the beverage concentrates contemplated are prepared with an initial volume of water to which the additional ingredients are added. Full strength beverages can be formed from the beverage concentrate by adding further volumes of water to the concentrate such that the concentrate is diluted to a full strength beverage. Typically, for example, full strength beverages can be prepared from the concentrates by combining approximately 1 part concentrate with between approximately 3 to approximately 7 parts water. In certain exemplary embodiments the full strength beverage is prepared by combining 1 part concentrate with 5 parts water. In certain exemplary embodiments the additional water used to form the full strength beverages is carbonated water. In certain other embodiments, a full strength beverage is directly prepared without the formation of a concentrate and subsequent dilution.

Those of ordinary skill in the art will understand that, for convenience, some ingredients are described here in certain cases by reference to the original form of the ingredient in which it is used in formulating or producing the beverage product. Such original form of the ingredient may differ from the form in which the ingredient is found in the finished beverage product. Thus, for example, in certain exemplary embodiments of the beverage products according to this disclosure, a natural nutritive sweetener and Lo Han Guo would typically be substantially homogenously dissolved and dispersed in the beverage. Likewise, other ingredients identified as a solid, concentrate (e.g., juice concentrate), etc. would typically be homogenously dispersed throughout the beverage or throughout the beverage concentrate, rather than remaining in their original form. Thus, reference to the form of an ingredient of a beverage product formulation should not be taken as a limitation on the form of the ingredient in the beverage product, but rather as a convenient means of describing the ingredient as an isolated component of the product formulation.

The beverage products disclosed here, comprising a natural nutritive sweetener and Lo Han Guo, include one or more tea components. As used herein, the term “tea” means any plant material (including fungus, e.g., mushrooms) that can be steeped or brewed to form a potable beverage. The term “tea” includes, for example, beverages made from leaf material from the genus Camellia, such as Camellia sinensis, Camellia assamica, Aspalathus linearis and the like. The leaves may have been subjected to a so-called “fermentation” step wherein they are oxidized by certain endogenous enzymes that are released during the early stages of “black tea” manufacture. This oxidation may even be supplemented by the action of exogenous enzymes such as oxidases, laccases and peroxidases. Alternatively the leaves may have been partially fermented (“oolong” tea) or substantially unfermented (“green” tea). The tea can be made from new growth buds and young leaves of the plant Camellia sinensis that have been steamed or fried to inactivate oxidation (“white” tea). The term “tea” further includes lemon, apple and orange flavored teas, cinnamon, spice, mint, rose, hibiscus and chamomile teas and the like.

As used herein, the term “tea component” includes one or more tea plant materials or portions thereof (e.g., leaves, stems, flowers, extracts, concentrates and the like) and/or one or more tea flavorings, e.g., an artificial or natural flavor that tastes like one or more of the teas described here. The tea component may be added to beverages comprising a natural nutritive sweetener and Lo Han Guo disclosed here in various forms including, but not limited to, an extract, a concentrate, a powder, as granules, or as combinations thereof. Optionally, the tea component may contain water.

Water is a basic ingredient in the beverages disclosed here, typically being the vehicle or primary liquid portion in which the remaining ingredients are dissolved, emulsified, suspended or dispersed. Purified water can be used in the manufacture of certain embodiments of the beverages disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain typical embodiments, water is present at a level of from about 80% to about 99.9% by weight of the beverage. In at least certain exemplary embodiments the water used in beverages and concentrates disclosed here is “treated water,” which refers to water that has been treated to reduce the total dissolved solids of the water prior to optional supplementation, e.g., with calcium as disclosed in U.S. Pat. No. 7,052,725. Methods of producing treated water are known to those of ordinary skill in the art and include deionization, distillation, filtration and reverse osmosis (“r-o”), among others. The terms “treated water,” “purified water,” “demineralized water,” “distilled water,” and “r-o water” are understood to be generally synonymous in this discussion, referring to water from which substantially all mineral content has been removed, typically containing no more than about 500 ppm total dissolved solids, e.g., 250 ppm total dissolved solids.

In at least certain exemplary embodiments the water used in beverages and concentrates disclosed here is “treated water,” which refers to water that has been treated to remove substantially all mineral content of the water prior to optional supplementation with one or more minerals and/or any of the components described herein as disclosed in U.S. Pat. No. 7,052,725. Methods of producing treated water are known to those of ordinary skill in the art and include deionization, distillation, filtration and reverse osmosis (“R-O”), among others. The terms “treated water,” “purified water,” “demineralized water,” “distilled water,” and “R-O water” are understood to be generally synonymous in this discussion, referring to water from which substantially all mineral content has been removed, typically containing no more than about 250 ppm total dissolved solids.

Additional sweeteners suitable for use in various embodiments of the sweetened tea beverage products comprising a natural nutritive sweetener and Lo Han Guo, include other natural and artificial or synthetic sweeteners. Suitable sweeteners and combinations of sweeteners are selected for the desired nutritional characteristics, taste profile for the beverage, mouthfeel and other organoleptic factors. Sweeteners suitable for at least certain such exemplary embodiments include, for example, sorbitol, mannitol, xylitol, glycyrrhizin, neohesperidin dihydrochalcone, D-tagatose, erythritol, meso-erythritol, malitol, maltose, lactose, fructo-oligosaccharides, steviol glycosides, acesulfame, aspartame, sucralose, saccharin, xylose, arabinose, levulose, isomalt, lactitol, maltitol, trehalose, and ribose, and protein sweeteners such as thaumatin, monellin, monetin, brazzein, L-alanine and glycine.

The beverage products disclosed here are based in part on the discovery of novel combinations of sweeteners that can be used to sweeten a tea beverage that is typically sweetened with high fructose corn syrup, to substantially preserve or closely replicate the taste, including mouthfeel of the beverage. As disclosed above, the sweetened tea beverages disclosed here employ a natural nutritive sweetener together with Lo Han Guo. Optionally, in addition to or as the natural nutritive sweetener, certain exemplary embodiments employ, e.g., nutritive, natural crystalline or liquid sweeteners such as sucrose, fructose, glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, and/or others, and mixtures of any of them. Exemplary artificial sweeteners suitable for use as an optional additional sweetener in at least certain embodiments of the beverage, products disclosed here include saccharin, cyclamate, aspartame, other dipeptides, acesulfame potassium, and other such potent sweeteners, and mixtures of any of them, as further discussed below. Exemplary natural non-nutritive potent sweeteners suitable for use as an optional additional sweetener in at least certain exemplary embodiments of the beverage products disclosed here include steviol glycosides, rebaudiosides, and related compounds, and mixtures of any of them, as further discussed below. Also, in at least certain exemplary embodiments of the beverage products disclosed here, combinations of one or more natural nutritive sweeteners and/or one or more artificial sweeteners with one or more natural non-nutritive potent sweeteners are used to provide the sweetness and other aspects of desired taste profile and nutritive characteristics. It should also be recognized that certain such sweeteners will, either in addition or instead, act as tastents, masking agents or the like in various embodiments of the beverage products disclosed here, e.g., when used in amounts below its (or their) sweetness perception threshold in the beverage in question.

The various sweeteners included in the beverage products disclosed here are edible consumables suitable for consumption and for use in beverages. By “edible consumables” is meant a food or beverage or an ingredient of a food or beverage for human or animal consumption. The sweetener or sweetening agent, as those terms are used here and in the claims, can be a nutritive or non-nutritive, natural or synthetic beverage ingredient or additive (or mixtures of them) which provides sweetness to the beverage, i.e., which is perceived as sweet by the sense of taste. The perception of flavoring agents and sweetening agents may depend to some extent on the interrelation of elements. Flavor and sweetness may also be perceived separately, i.e., flavor and sweetness perception may be both dependent upon each other and independent of each other. For example, when a large amount of a flavoring agent is used, a small amount of a sweetening agent may be readily perceptible and vice versa. Thus, the oral and olfactory interaction between a flavoring agent and a sweetening agent may involve the interrelationship of elements.

A natural embodiment of the beverage products disclosed here is natural in the sense that it does not contain anything artificial or synthetic (including any color additives regardless of source) that would not normally be expected to be in the food. As used herein, therefore, a “natural” beverage composition is defined in accordance with the following guidelines: Raw materials for a natural ingredient exists or originates in nature, or the ingredient itself exists in nature. Biological synthesis involving fermentation and enzymes can be employed, but synthesis with chemical reagents is not utilized. Artificial colors, preservatives, and flavors are not considered natural ingredients. Ingredients may be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. See 21 CFR §170.3(o)(24)) are considered incidental additives and may be used if removed appropriately.

In at least certain exemplary embodiments of the beverage products disclosed here, comprising a natural nutritive, crystalline or liquid sweetener and Lo Han Guo, the sweetener component can be present in an amount of from about 0.1% to about 20% by weight of the beverage, such as from about 6% to about 16% by weight, depending upon the desired level of sweetness for the beverage. In certain exemplary embodiments, a sweetener (e.g., a natural nutritive sweetener) is present in an amount of at least about 8%, 9%, 10%, 11%, or 12% by weight of a full strength beverage. In other exemplary embodiments, a sweetener (e.g., a natural nutritive sweetener) is present in an amount of at least about 50%, 55%, 60%, 65%, or 70% by weight or volume of a full strength beverage. To achieve desired beverage uniformity, texture and taste, standardized liquid sugars as are commonly employed in the beverage industry can be used. Typically such standardized sweeteners are free of traces of non-sugar solids which could adversely affect the flavor, color or consistency of the beverage. Typical nutritive, natural crystalline or liquid sweeteners include, for example, sucrose, liquid sucrose, fructose, liquid fructose, glucose, liquid glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, and/or others. To achieve desired beverage uniformity, texture and taste, in certain exemplary embodiments of the natural beverage products disclosed here, standardized liquid sugars as are commonly employed in the beverage industry can be used. Typically such standardized sweeteners are free of traces of nonsugar solids which could adversely affect the flavor, color or consistency of the beverage.

The term “nutritive sweetener” refers generally to sweeteners which provide significant caloric content in typical usage amounts, e.g., more than about 5 calories per 8 oz. serving of beverage. As used herein, a “potent sweetener” means a sweetener which is at least twice as sweet as sugar, that is, a sweetener which on a weight basis requires no more than half the weight of sugar to achieve an equivalent sweetness. For example, a potent sweetener may require less than one-half the weight of sugar to achieve an equivalent sweetness in a beverage sweetened to a level of 10 degrees Brix with sugar. Potent sweeteners include both nutritive and non-nutritive sweeteners. In addition, potent sweeteners include both natural potent sweeteners and artificial potent sweeteners. However, for natural beverage products disclosed here, only natural potent sweeteners are employed. Commonly accepted potency figures for certain potent sweeteners include, for example,

| | |
|---|---|
| Cyclamate | 30 times as sweet as sugar |
| Stevioside | 100–250 times as sweet as sugar |
| Mogroside V | 100–300 times as sweet as sugar |
| Rebaudioside A | 150–300 times as sweet as sugar |
| Acesulfame-K | 200 times as sweet as sugar |
| Aspartame | 200 times as sweet as sugar |
| Saccharine | 300 times as sweet as sugar |
| Neohesperidin | 300 times as sweet as sugar |
| dihydrochalcone | |
| Sucralose | 600 times as sweet as sugar |
| Neotame | 8,000 times as sweet as sugar |

As used herein, a “non-nutritive sweetener” is one which does not provide significant caloric content in typical usage amounts, i.e., is one which imparts less than 5 calories per 8 oz. serving of beverage to achieve the sweetness equivalent of 10 Brix of sugar. As used herein, “reduced calorie beverage” means a beverage having at least a 25% reduction in calories per 8 oz. serving of beverage as compared to the full calorie version, typically a previously commercialized full-calorie version. As used herein, a “low-calorie beverage” has fewer than 40 calories per 8 oz serving of beverage. As used herein, “zero-calorie” or “diet” means having less than 5 calories per serving, e.g., per 8 oz. for beverages.

Artificial and/or additional natural non-nutritive potent sweeteners are suitable for use in at least certain exemplary embodiments of the beverages disclosed here, comprising a natural nutritive sweetener and Lo Han Guo. Such artificial potent sweeteners include peptide based sweeteners, for example, acesulfame potassium, aspartame, neotame, and alitame, and non-peptide based sweeteners, for example, sodium saccharin, calcium saccharin, acesulfame potassium, sodium cyclamate, calcium cyclamate, neohesperidin dihydrochalcone, sucralose, and mixtures of any of them. Alitame may be less desirable for caramel-containing beverages where it has been known to form a precipitate. Suitable natural non-nutritive potent sweeteners include, for example, in addition to Lo Han Guo powder, steviol glycosides, such as rebaudiosides, stevioside and related compounds, as discussed further below. Non-nutritive, high potency sweeteners typically are employed at a level of milligrams per fluid ounce of beverage, according to their sweetening power, any applicable regulatory provisions of the country where the beverage is to be marketed, the desired level of sweetness of the beverage, etc. It will be within the ability of those skilled in the art, given the benefit of this disclosure, to select suitable additional or alternative sweeteners for use in various embodiments of the beverages comprising a natural nutritive sweetener and Lo Han Guo disclosed here.

As disclosed above, the beverage products disclosed here employ Lo Han Guo. Lo Han Guo is a potent sweetener which can be provided as a natural nutritive or natural non-nutritive sweetener. For example. Lo Han Guo juice concentrate may be a nutritive sweetener, and Lo Han Guo powder may be a non-nutritive sweetener. The sweetener Lo Han Guo, which has various different spellings and pronunciations, can be obtained from fruit of the plant family Cucurbitaceae, tribe Jollifieae, subtribe Thladianthinae, genus Siraitia. Lo Han Guo often is obtained from the genus/species S. grosvenorii, S. siamensis, S. silomaradjae, S. sikkimensis, S. africana, S. borneensis, and S. taiwaniana. Suitable fruit includes that of the genus/species S. grosvenorii, which is often called Lo Han Guo fruit. Lo Han Guo contains triterpene glycosides or mogrosides, which constituents may be used as Lo Han Guo sweeteners. Lo Han Guo can be used as the juice or juice concentrate, powder, etc. In certain exemplary embodiments, Lo Han Guo juice contains at least about 0.1%, e.g., from 0.1% to about 15%, mogrosides, such as mogroside V, mogroside IV, (11-oxo-mogroside V), siamenoside and mixtures thereof. Sweeteners from other fruits, vegetables or plants also may be used as natural or processed sweeteners or sweetness enhancers in at least certain exemplary embodiments of the beverages comprising a natural nutritive sweetener and Lo Han Guo disclosed here.

Lo Han Guo can be produced, for example, as discussed in U.S. Pat. No. 5,411,755 or by any other art-recognized methods. As discussed in U.S. Pat. No. 5,411,755, the fresh fruit can be selected, stored, and processed to provide a high level of sweetness, remove/avoid decayed fruit, and facilitate removal of the outer peel from the inner meat.

Typically the fruit is picked at a slightly under ripe state and allowed to ripen during storage. Alternatively the fruit may be allowed to fully ripen on the vine. During the final stages of ripening, some moisture is lost from the fruit and there is a slight contraction of the inner fruit and separation from the outer peel. Also, the level of sweetness increases. Under-ripe fruit is more firm, tends to be less sweet and may be bitter. Ripe fruit infected by insects such as fruit fly larvae, rapidly decays and should be removed and discarded.

The fruit is typically thoroughly washed to remove all adhering dirt, in certain aspects using disinfectant solutions. Washing may be accomplished by dumping the fruit into troughs of moving water, separating them from the water, and spray washing the fruit. They can also be treated with strong water sprays as they move along a roller-type conveyor. The fruit is then sorted e.g., by hand or machine, to remove all partially or wholly decayed fruit or fruit which has had insect damage. The wash water may contain chlorine (about 5 to 20 ppm) or other disinfectant.

The washed and sorted fruit is typically prepared for extraction optionally by removing the crest or peel by any conventional method for coring fruits and vegetables. The fruit can be cut in half and the center scooped out by hand or by mechanical separators. Steam peeling is also acceptable. Optionally, the fruit does not have to be peeled as long as peel and seeds are removed quickly from the mashed fruit. This prevents off-flavor formation due to juice and peel contact.

It is typically desirable that the fruit is mashed in an oxygen-restricted atmosphere. Equipment used for mashing apples, potatoes and other soft fruits and vegetables can be used to pulverize the fruit core, such that seed break-up is minimal. One type of mashing apparatus, a Ratz Muhle, grates the fruit to a mash; a hammer mill (e.g., FITZMIL™) can be used to comminute the fruit such that it passes through the finisher.

Other common apparatuses for forming a puree or comminuted juice include, but are not limited to, a hydraulic cider press, a pneumatic juice press, a continuous screw type press, a continuous plate press, a semi-continuous plate press, a horizontal basket press, a screening centrifuge, a rack and cloth press, a continuous belt press and the like. Juice pressing methods are described in Nelson et al., Fruit and Vegetable Juice Processing Technology, AVI Publishing Co., pp 216-229 (1980).

Lo Han Guo contains a large number of seeds. The peel and seeds are about 40-50% by weight of the fruit. Water can be added to the peeled fruit during processing to help separate the seeds. Although this will dilute the juice, the water can be removed in an optional subsequent concentration step.

The raw juice or fruit as it comes from the mashing, comminuting or extracting process contains pulp, seeds, and possibly peel. These are separated from the juice in a “finisher” or centrifugal extractor which contains a screen. The screen opening size can range from about 0.5 mm to about 6.5 mm. When the screen opening is larger than 6.5 mm, small seeds pass into the juice and contaminate it.

Smaller screens will retain pulp along with the seeds. The opening size can be adjusted depending on the desired thickness of the resulting puree. Finished juice, that which has gone through the screening process, can also be passed through a centrifuge to adjust pulp level. As used herein, the term “pulp” refers to the pectin, cellulose and small fruit pieces containing juice.

The juice obtained from the process steps described above is not a clear juice but is more like a juice puree. The term “juice,” as used herein, includes such juice puree or juice with pulp. When the pulp or solid particles are substantially removed, the juice is referred to as clear juice.

The peel, seeds and/or pulp separated from the juice can optionally be extracted with hot water to recover more juice. Extraction conditions should be controlled to minimize extraction of unwanted off-flavors. The ratio of water to peel, seeds and/or pulp should be less than about 2:1, in certain exemplary embodiments about 1.5:1 to about 0.7:1, or about 1:1. Water temperature should be below about 100° C, in exemplary embodiments about 70° C. to about 90° C., or about 80° C. Contact time between the water and peel/seed/pulp should be less than about 1 hour, in exemplary embodiments about 20 minutes to about 40 minutes, or about 30 minutes. The extract can be separated from the solid material by conventional techniques, such as settling, straining, filtering or centrifuging. The extract obtained can be combined with the juice previously separated from peel, seeds and/or pulp.

Lo Han Guo can be provided in the beverage products described here in a variety of forms including, but not limited to, juice, concentrates, purees, milks, and other forms such as powders, crystals, leathers and the like. In certain exemplary embodiments, Lo Han Guo is provided as a juice concentrate. The term “juice concentrate” as used herein will be understood by those of skill in the art to mean the form in which it is used rather than its form in the beverage product. Thus, for example, although juice concentrate is provided at a certain concentration, the final percentage of Lo Han Guo will be that percentage present in the final form of the beverage (i.e., as a lower percentage because the juice will be mixed with other ingredients of the formulation).

Typically, the amount of Lo Han Guo juice concentrate used in full strength (i.e., not concentrated) beverages described here will be less than 1% of the final beverage formulation. In certain exemplary embodiments, Lo Han Guo juice concentrate is present in beverages described here at a concentration of less than about 1%, 0.5%, 0.1%, 0.09%, 0.08%, 0.07%, 0.06% or 0.05% by weight. In certain exemplary embodiments, Lo Han Guo juice concentrate is present in beverage described here at a concentration of at least about 0.0005%, 0.001%, 0.002%, 0.003%, 0.004% or 0.005% by weight. In certain exemplary embodiments, Lo Han Guo juice concentrate is present in beverages described here at a concentration of between about 0.01% and about 0.05% by weight. In certain exemplary embodiments, Lo Han Guo juice concentrate is present in beverages described here at a concentration of from about between about 0.03% and about 0.04%. In certain exemplary embodiments, Lo Han Guo juice concentrate is present in beverages described here at a concentration of from between about 0.06% and about 0.3%. In certain exemplary embodiments, Lo Han Guo juice concentrate is present in beverages described here at a concentration of from about between about 0.18% and about 0.24%.

In certain exemplary embodiments, beverage products described here contain one or more acids. Acid used in beverages comprising a natural nutritive sweetener and Lo Han Guo disclosed here can serve any one or more of several functions, including, for example, lending tartness to the taste of the beverage, enhancing palatability, increasing thirst quenching effect, modifying sweetness and acting as a mild preservative. Suitable acids are known and will be apparent to those skilled in the art given the benefit of this disclosure. Exemplary acids suitable for use in some or all embodiments of the beverages comprising a natural nutritive sweetener and Lo Han Guo disclosed here include phosphoric acid, citric acid, malic acid, tartaric acid, lactic acid, formic acid, ascorbic acid, fumaric acid, gluconic acid, succinic acid, maleic acid and adipic acid and mixtures of any of them. In certain exemplary embodiments citric acid and/or ascorbic acid are used.

The acid can be used in solution form, for example, and in an amount sufficient to provide the desired pH of the beverage. Typically, for example, the one or more acids of the acidulant are used in amount, collectively, of from about 0.01% to about 1.0% by weight of the beverage, e.g., from about 0.05% to about 0.5% by weight of the beverage, such as 0.1% to 0.25% by weight of the beverage, depending upon the acidulant used, desired pH, other ingredients used, etc. The pH of at least certain exemplary embodiments of the beverages comprising a natural nutritive sweetener and Lo Han Guo disclosed here can be a value within the range of from about 2.0 to about 7.0, e.g., from about 2.0 to about 5.0. The acid in certain exemplary embodiments enhances beverage flavor. Too much acid can impair the beverage flavor and result in sourness or other off-taste, while too little acid can make the beverage taste flat.

The particular acid or acids chosen and the amount used will depend, in part, on the other ingredients, the desired shelf life of the beverage product, as well as effects on the beverage pH, titratable acidity, and taste. Those skilled in the art, given the benefit of this disclosure, will recognize that when preparing beverage products containing peptide-based artificial sweeteners such as aspartame, the resulting beverage composition is best-maintained below a certain pH to retain the sweetening effect of the artificial sweetener. In the formation of calcium-supplemented beverages, the presence of calcium salts increases the pH which requires additional acids to both assist the dissolution of the salt and maintain a desirable pH for stability of the artificial sweetener. The presence of the additional acid in the beverage composition, which increases the titratable acidity of the composition, will result in a more tart or sour taste to the resulting beverage. It will be within the ability of those skilled in the art, given the benefit of this disclosure, to select a suitable acid or combination of acids and the amounts of such acids for the acidulant component of any particular embodiment of the beverages comprising a natural nutritive sweetener and Lo Han Guo disclosed here.

Certain exemplary embodiments of the sweetened tea beverages disclosed here comprising a natural nutritive sweetener and Lo Han Guo also may contain small amounts of alkaline agents to adjust pH. Such agents include, e.g., potassium hydroxide, sodium hydroxide and potassium carbonate. For example, the alkaline agent potassium hydroxide may be used in an amount of from about 0.02 to about 0.04% by weight, with an amount of about 0.03% being typical for certain beverages. The amount will depend, of course, on the type of alkaline agents and on the degree to which the pH is to be adjusted.

The beverages comprising a natural nutritive sweetener and Lo Han Guo disclosed here optionally contain a flavor composition, for example, any one or more suitable natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, mandarin orange, tangerine, tangelo, pomelo, lemon, lime and grapefruit, and such flavors as apple, grape, cherry, and pineapple flavors and the like, and mixtures thereof. In certain exemplary embodiments the beverage concentrates and beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Also included within the term “botanical flavor” are synthetically prepared flavors made to simulate botanical flavors derived from natural sources. Examples of such flavors include cola flavors, tea flavors, and the like, and mixtures thereof. The flavor component can further comprise a blend of various of the above-mentioned flavors. In certain exemplary embodiments of the beverage concentrates and beverages a cola flavor component is used or a tea flavor component. The particular amount of the flavor component useful for imparting flavor characteristics to the beverages described here will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in at least certain exemplary embodiments of the beverages comprising a natural nutritive sweetener and Lo Han Guo disclosed here include, e.g., fruit, vegetable and berry juices. Juices can be employed in the beverages described here in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a beverage having the desired flavor.

Examples of suitable juice sources include, but are not limited to, plum, prune, date, currant, fig, grape, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, mandarin orange, tangelo, pomelo, lime, tangerine, mandarin, grapefruit and the like. Numerous additional and alternative juices suitable for use in at least certain exemplary embodiments will be apparent to those skilled in the art given the benefit of this disclosure. In the beverages described here employing juice, juice may be used, for example, at a level of at least about 0.2% by weight of the beverage. In certain exemplary embodiments juice is employed at a level of from about 0.2% to about 40% by weight of the beverage. Typically, juice can be used, if at all, in an amount of from about 1% to about 20% by weight.

Certain such juices which are lighter in color can be included in the formulation of certain exemplary embodiments to adjust the flavor and/or increase the juice content of the beverage without darkening the beverage color. Examples of such juices include apple, pear, pineapple, peach, lemon, lime, orange, mandarin orange, tangelo, pomelo, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use in at least certain exemplary embodiments of the beverages comprising a natural nutritive sweetener and Lo Han Guo disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in certain exemplary embodiments comprises greater than about 3% of the mixture of flavorings and emulsifier. In certain exemplary embodiments the emulsifier is from about 5% to about 30% of the mixture.

Weighting agents, which can also act as clouding agents, are typically used to keep emulsion droplets dispersed in the beverage. Examples of such weighting agents are brominated vegetable oils, rosin esters and, in particular, ester gums. Any weighting agent that is commercially available can be used in this invention. Besides weighting agents, emulsifiers and emulsion stabilizers can be used to stabilize the flavor emulsion droplets. Examples of such emulsifiers and emulsion stabilizers include gums, pectins, cellulose, polysorbates, sorbitan esters and propylene glycol alginates.

In certain exemplary embodiments of the beverage products (e.g., beverages, concentrates and the like) disclosed here comprising a natural nutritive sweetener and Lo Han Guo have a taste and/or mouthfeel that are similar to or the same as the taste and/or mouthfeel of the same formulation sweetened with high fructose corn syrup instead of a natural nutritive sweetener and Lo Han Guo. Reformulation of a beverage product containing high fructose corn syrup as a sweetener using instead sweeteners comprising a natural nutritive sweetener and Lo Han Guo, can produce beverages having the same or similar taste and/or mouthfeel as the beverage product containing high fructose corn syrup as a sweetener.

As used herein, the term “taste” refers to the flavor of the beverage and includes sweetness, sourness, bitterness, saltiness and umami (e.g., savoriness or meatiness). In certain exemplary embodiments of the invention, taste refers to beverage sweetness. As used herein, the term “mouthfeel” is intended to refer to a tactile sensation a beverage gives to the mouth (i.e., due to physical and chemical interactions in the mouth). It is evaluated from initial perception on the palate through to swallowing. Mouthfeel modifiers include qualities such as creaminess, thickness, bubbly characteristics and the like.

A synergistic effect is found in taste and mouthfeel properties of beverages sweetened with a natural nutritive sweetener (e.g., sucrose) and Lo Han Gou. The synergistic effect results in achieving the same or similar taste and/or mouthfeel in beverages containing a natural nutritive sweetener and Lo Han Gou when compared to a beverage product containing high fructose corn syrup as a sweetener. A synergistic effect is found in taste and feel properties of tea beverages sweetened with a natural nutritive sweetener and Lo Han Gou. A synergistic effect is also found in taste and mouthfeel properties of tea beverages sweetened with a composition consisting of a sucrose and Lo Han Gou.

Carbon dioxide is used to provide effervescence to certain exemplary embodiments of the beverages comprising a natural nutritive sweetener and Lo Han Guo disclosed here. Any of the techniques and carbonating equipment known in the art for carbonating beverages can be employed. Carbon dioxide can enhance the beverage taste and appearance and can aid in safeguarding the beverage purity by inhibiting and destroying objectionable bacteria. In certain exemplary embodiments, for example, the beverage has a CO₂ level up to about 7.0 volumes carbon dioxide. Some embodiments may have, for example, from about 0.5 to 5.0 volumes of carbon dioxide. One volume of carbon dioxide is defined as the amount of carbon dioxide absorbed by any given quantity of water at 60° F. (16° C.) temperature and atmospheric pressure. A volume of gas occupies the same space as does the water by which it is absorbed. The carbon dioxide content can be selected by those skilled in the art based on the desired level of effervescence and the impact of the carbon dioxide on the taste or mouthfeel of the beverage. The carbonation can be natural or synthetic.

Optionally, caffeine can be added to various embodiments of the beverages comprising a natural nutritive sweetener and Lo Han Guo disclosed here. The amount of caffeine added is determined by the desired beverage properties, any applicable regulatory provisions of the country where the beverage is to be marketed, etc. The caffeine must be of a purity acceptable for use in foods and beverages. The caffeine can be natural (e.g., from kola, cocoa nuts, coffee and/or tea) or synthetic in origin. If caffeine is present in the formulation prior to adding additional caffeine (e.g., in tea beverages), the caffeine present in them should be factored into the percentage of caffeine in the beverage.

The amount of caffeine can be from about 0.002% to about 0.05% by weight of the single strength beverage. In certain exemplary embodiments, the amount of caffeine is from about 0.005% to about 0.02%. In certain exemplary embodiments caffeine is included at a level of 0.02 percent or less by weight of the beverage. For concentrates or syrups, the caffeine level can be from about 0.006% to about 0.15%. Caffeine levels can be higher, for example, if flavored coffees which have not been decaffeinated are used since these materials contain caffeine naturally.

In addition to or instead of the various optional ingredients disclosed above, the beverage concentrates and beverages disclosed here comprising a natural nutritive sweetener and Lo Han Guo, may optionally contain any other suitable ingredient(s), including, for example, any of those typically found in beverage formulations. These additional ingredients, for example, can typically be added to a stabilized beverage concentrate. Examples of such additional ingredients include, but are not limited to, caramel and other coloring agents or dyes, antifoaming agents, gums, emulsifiers, cloud components, and nutritional supplements.

Examples of nutritional supplement ingredients are known to those of ordinary skill in the art and include, without limitation, vitamins, minerals, herbs or botanicals, amino acids, or essential fatty acids or enzymes, proteases, tissues, organs, glands or portions thereof. Vitamins include, but are not limited to, vitamin A, vitamin D, vitamin E (tocopherol), vitamin C (ascorbic acid), vitamin B, (thiamine), vitamin B₂ (riboflavin), vitamin B₃ (niacin), vitamin B₅ (pantothenic acid), vitamin B₆ (pyridoxine), vitamin B₇ (biotin), vitamin B₉ (folic acid), vitamin B₁₂ (cyanocobalamin), vitamin K (naphthoquinone), vitamin D (D₁ (molecular compound of ergocalciferol with lumisterol, 1:1); D₂ (ergocalciferol or calciferol); D₃ (cholecalciferol); D₄ (dihydrotachysterol); D₅ (sitocalciferol)), and combinations thereof. Supplements are typically present in amounts generally accepted under good manufacturing practices and are typically present in amounts between about 1% to about 100% RDV, where such RDV are established. In certain exemplary embodiments, the nutritional supplement ingredient(s) may be present in an amount of from about 5% to about 20% RDV, where established.

Beverage compositions disclosed herein can optionally include one or more colorants. As used herein, the “colorant” is intended to mean any compound that imparts color, which includes, but is not limited to natural pigments, synthetic pigment, color additives and mixtures thereof. Natural and artificial colors may be used. One or more FD&C dyes (e.g., yellow #5, blue #2, red #40) and/or FD&C lakes can be used to color beverages described herein. Exemplary lake dyes which may be used in beverages described herein are the FDA-approved Lake, such as Lake red #40, yellow #6, blue #1, and the like. Additionally, a mixture of FD&C dyes or a FD&C lake dye in combination with other conventional food and food colorants may be used. Other coloring agents, for example, natural agents may be utilized. Non-limiting examples of such other coloring agents include fruit and vegetable juices and/or powders, riboflavin, carotenoids (for example, beta-carotene), tumeric, and lycopenes.

The exact amount of coloring agent used will vary, depending on the agents used and the intensity desired in the finished product. Generally, if utilized, the coloring agent should be present at a level of from about 0.0001% to about 0.5%, from about 0.001% to about 0.1%, or from about 0.004% to about 0.1%, by weight or volume of the composition.

Preservatives may be used in at least certain embodiments of the beverages disclosed here comprising a natural nutritive sweetener and Lo Han Guo. That is, at least certain exemplary embodiments contain an optional dissolved preservative system. Solutions with a pH below 4 and especially those below 3 typically are “microstable,” i.e., they resist growth of microorganisms, and so are suitable for longer term storage prior to consumption without the need for further preservatives. However, an additional preservative system can be used if desired. If a preservative system is used, it can be added to the beverage product at any suitable time during production, e.g., in some cases prior to the addition of the sweetener. As used here, the terms “preservation system” or “preservatives” include all suitable preservatives approved for use in food and beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and combinations thereof.

Preservatives can be used in amounts not exceeding mandated maximum levels under applicable laws and regulations. The level of preservative used typically is adjusted according to the planned final product pH, as well as an evaluation of the microbiological spoilage potential of the particular beverage formulation. The maximum level employed typically is about 0.05% by weight of the beverage. It will be within the ability of those skilled in the art, given the benefit of this disclosure, to select a suitable preservative or combination of preservatives for beverages according to this disclosure.

Other methods of beverage preservation suitable for at least certain exemplary embodiments of the beverage products disclosed here include, e.g., aseptic packaging and/or heat treatment or thermal processing steps, such as hot filling and tunnel pasteurization. Such steps can be used to reduce yeast, mold and microbial growth in the beverage products. For example, U.S. Pat. No. 4,830,862 to Braun et al. Discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate. In general, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

In accordance with certain exemplary embodiments of the sweetened tea beverages disclosed herein, the beverage is substantially clear. That is, the beverage has substantially no turbidity and substantially no color.

The following example is a specific embodiment of the present invention but is not intended to limit it. The contents of all references, patents and published patent applications cited throughout this application are hereby incorporated by reference in their entirety for all purposes.

### EXAMPLE I

### Lo Han Guo-Containing, Sugar Sweetened Tea

It is well known to food technologists that simply replacing high fructose corn syrup with sugar results in a delicate but detectable taste difference. It has been surprisingly discovered that a small amount of Lo Han Guo combined with sugar can make sugar-sweetened tea taste like high fructose corn syrup-sweetened tea. The beverage products disclosed here are based in part on the discovery of novel combinations of sweeteners that can be used to sweeten a tea beverage that is typically sweetened with high fructose corn syrup, to substantially preserve or closely replicate the taste, including mouthfeel of the beverage.

A small amount of Lo Han Guo combined with sucrose was used to replace high fructose corn syrup in a sweetened a tea beverage (Table 1). The beverage products disclosed herein comprise greater than about 8 degrees Brix of sugar.

TABLE 1

| | | | Lo Han Guo- |
|---|---|---|---|
| | | | Containing |
| | | Sugar Control | Sugar- |
| Ingredient | Control Tea | Tea | Sweetened Tea |
| HFCS-55 | 123.99 g | none | None |
| Sucrose | none | 92.31 g | 87.31 g |
| Lo Han Guo juice | none | none | 0.35 g |
| concentrate | | | |
| Citric Acid | 0.99 g | 0.99 g | 0.99 g |
| Ascorbic Acid | 0.38 g | 0.38 g | 0.38 g |
| Flavors | 1.70 g | 1.76 g | 1.76 g |
| Water | Top off to 1 | Top off to 1 | Top off to 1 |
| | liter | liter | liter |

The Lo Han Guo and sucrose sweetened tea beverage was judged as tasting substantially the same as the control tea formulation containing high fructose corn syrup.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

What is claimed is:

1. A sweetened tea beverage product comprising:
a tea component;
a natural nutritive sweetener present in an amount of at least 8% by weight and
Lo Han Guo.

2. The sweetened tea beverage product of claim 1, comprising in addition to the natural nutritive sweetener and Lo Han Guo a non-nutritive, natural sweetener which is not Lo Han Guo.

3. The sweetened tea beverage product of claim 1, wherein the natural nutritive sweetener is selected from the group consisting of sucrose, fructose, glucose, invert sugar, high fructose corn syrup and combinations thereof.

4. The sweetened tea beverage product of claim 1, wherein the natural nutritive sweetener is sucrose.

5. The sweetened tea beverage product of claim 1, wherein Lo Han Guo is a Lo Han Guo juice concentrate.

6. The sweetened tea beverage product of claim 5, wherein the Lo Han Go juice concentrate is present in an amount from about 0.01% to 0.05% by weight

7. The sweetened tea beverage product of claim 5, wherein the Lo Han Go juice concentrate is present in an amount from about 0.03% to 0.04% by weight

8. The sweetened tea beverage product of claim 1, wherein the beverage composition contains caffeine.

9. The sweetened tea beverage product of claim 1, wherein the beverage composition is decaffeinated.

10. The sweetened tea beverage product of claim 1, further comprising one or more components selected from the group consisting of acid, color, flavor composition, carbonation, nutritional supplement and emulsifying agent.

11. The sweetened tea beverage product of claim 1, further comprising an acid selected from the group consisting of phosphoric acid, citric acid, malic acid, tartaric acid, lactic acid, formic acid, ascorbic acid, gluconic acid, succinic acid, maleic acid, adipic acid and combinations thereof.

12. The sweetened tea beverage product of claim 11, wherein the acid is citric acid, ascorbic acid or a combination thereof.

13. The sweetened tea beverage product of claim 1, wherein the tea component comprises tea selected from the group consisting of black tea, oolong tea, green tea, white tea and combinations thereof.

14. The sweetened tea beverage product of claim 1, wherein the beverage is substantially clear.

15. A sweetened tea beverage concentrate comprising:
a tea component;
a natural nutritive sweetener present in an amount of at least 48% by weight and
Lo Han Guo.

16. The sweetened tea beverage concentrate of claim 15, wherein the natural nutritive sweetener is present in an amount of at least 8% by weight when the beverage concentrate is diluted to a full strength beverage product.

17. The sweetened tea beverage concentrate of claim 15, comprising an additional non-nutritive, natural sweetener.

18. The sweetened tea beverage concentrate of claim 15, wherein the natural nutritive sweetener is selected from the group consisting of sucrose, fructose, glucose, levulose, invert sugar, high fructose corn syrup and combinations thereof.

19. The sweetened tea beverage concentrate of claim 15, wherein the natural nutritive sweetener is sucrose.

20. The sweetened tea beverage concentrate of claim 15, wherein Lo Han Guo is a Lo Han Guo juice concentrate.

21. The sweetened tea beverage concentrate of claim 20, wherein the Lo Han Go juice concentrate is present in an amount from about 0.06% to 0.3% by weight

22. The sweetened tea beverage concentrate of claim 21, wherein the Lo Han Go juice concentrate is present in an amount to yield about 0.01% to 0.05% by weight in a full strength beverage.

23. The sweetened tea beverage concentrate of claim 20, wherein the Lo Han Go juice concentrate is present in an amount from about 0.18% to 0.24% by weight

24. The sweetened tea beverage concentrate of claim 23, wherein the Lo Han Go juice concentrate is present in an amount to yield about 0.03% to 0.04% by weight in a full strength beverage.

25. The sweetened tea beverage concentrate of claim 15, wherein the beverage composition contains caffeine.

26. The sweetened tea beverage concentrate of claim 15, wherein the beverage composition is decaffeinated.

27. The sweetened tea beverage concentrate of claim 15, further comprising one or more components selected from the group consisting of acid, color, flavor composition, carbonation, nutritional supplement and emulsifying agent.

28. The sweetened tea beverage concentrate of claim 15, further comprising an acid selected from the group consisting of phosphoric acid, citric acid, malic acid, tartaric acid, lactic acid, formic acid, ascorbic acid, fumaric acid, gluconic acid, succinic acid, maleic acid, adipic acid and combinations thereof.

29. The sweetened tea beverage concentrate of claim 15, further comprising citric acid, ascorbic acid or a combination thereof.

30. The sweetened tea beverage concentrate of claim 15, wherein the tea component comprises tea selected from the group consisting of black tea, oolong tea, green tea, white tea and combinations thereof.

31. A full strength sweetened tea beverage produced by diluting a beverage concentrate comprising a tea component, a natural nutritive sweetener present in an amount of at least 48% by weight, and Lo Han Guo with water.

32. The full strength sweetened tea beverage of claim 31, comprising one part beverage concentrate and five parts water.

33. A sweetened tea beverage product consisting of:
a tea component;
sucrose present in an amount of at least 8% by weight; and
Lo Han Guo.
